(19) United States
(12) Patent Application Publication
(10) Pub. No.: US 2007/0084488 A1
(43) Pub. Date: Apr. 19, 2007

(54) CLEANING DEVICE FOR INTERNAL COMBUSTION ENGINE

(76) Inventor: Mei-Hua CHIANG, Yuen Lin Chen (TW)

Correspondence Address: LEONG C LEI, PMB # 1008, 1867 YGNACIO VALLEY ROAD, WALNUT CREEK, CA, 94598, US

(21) Appl. No.: 11/559,912

(22) Filed: Nov. 15, 2006

Related U.S. Application Data
(62) Division of application No. 10/647,312, filed on Aug. 26, 2003.

(51) Int. Cl. B08B 3/02

(52) U.S. Cl. 134/100.1; 134/102.2; 134/166 R; 134/169 A; 134/169 R

(57) ABSTRACT

A cleaning device for internal combustion engine by way of suction force generated at the air-inlet tube of the engine is disclosed. The tapered air passage accelerates the air stream to produce a suction force, or a moveable or adjustable valve device to change the surface area of the air passage so as to control the effect of vacuum, and the cleaning solution is sucked into the air-inlet tube to clean away the accumulated carbon and debris in the valves or the internal combustion engine.

### CROSS-REFERENCE

This is a division of the co-pending patent application Ser. No. 10/647,312, filed Aug. 26, 2003.

### BACKGROUND OF THE INVENTION

(a) Technical Field of the Invention

The present invention relates to a cleaning device, and in particular, a cleaning device for internal combustion engine by way of a suction force generated at an air-inlet tube to the engine and by controlling the suction force to withdraw a cleaning solution into the internal combustion engine to clean the accumulated carbon and the like debris accumulated therein.

(b) Description of the Prior Art

After a period of operation of an internal combustion engine, carbons and/or the like materials are accumulated at tubes or conduits or cylinders of the internal combustion engine. Therefore, it is an indispensable step to remove the accumulated carbons and debris or to clean away the accumulated carbons.

Conventional ways of cleaning the internal combustion engine is by using a cleaning solution injected into the cylinders via a hole for mounting spark plug. Another conventional way is by introducing a cleaning solution into a manifold connected to the internal combustion engine, and a suction force generated will withdraw the cleaning solution into the cylinder and remove the accumulated carbons. However, this conventional method is not effective for cleaning diesel engine.

The above conventional methods are not effective and the drawbacks of these methods are as follows:

a. If the cleaning solution is introduced from the hole for mounting the spark plug or via a nozzle, the air inlet manifold will not be cleaned before the internal combustion engine is cleaned, and therefore the air valve of the engine has to be cleaned again. This is not economical.

b. For gasoline fuel engines, the air valve cannot be cleaned as the cleaning solution does not go through the air valve.

c. There is no air valve in diesel engine and therefore suction force generated by the engine is insufficient, and cleaning solution cannot be introduced into the air inlet manifold to clean the air-inlet manifold. If the speed of the engine is lifted in order to increase the suction force, the cylinder will probably explode.

In view of the above drawbacks, it is an object of the present invention to provide a cleaning device for internal combustion engine, which mitigates the shortcomings of the conventional method.

### SUMMARY OF THE INVENTION

An object of the present invention is to provide a cleaning device for internal combustion engine by way of suction force generated at an air-inlet tube, comprising a container containing a cleaning solution, suction generator connected in series with the air-inlet tube of the internal combustion engine and a guiding tube connecting the container and the suction generator or the air-inlet tube, characterized in that an air-stream passage is provided at the suction generator and has an internal diameter smaller than that of the air inlet tube such that the air stream via the passage is accelerated to produce a suction force so as to withdraw the cleaning solution via the guiding tube into the air inlet tube into the cylinder of the internal combustion engine to clean accumulated carbon or debris.

Yet another object of the present invention is to provide a cleaning device for internal combustion engine, wherein an adjustable or moveable block plate is provided to change the flowrate of air stream to effect the vacuum therein based on the capacity of the cylinder of the internal combustion engine.

Yet a further object of the present invention is to provide a cleaning device for internal combustion engine, wherein the guiding tube for leading the cleaning solution is provided with at least an adjusting switch, facilitating the control of the flowrate of the cleaning solution.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a first mode of a first preferred embodiment of the present invention.

FIG. 1B is a second mode of the first preferred embodiment of the present invention.

FIG. 1C is a third mode of the first preferred embodiment of the present invention.

FIG. 2A is a first mode of a second preferred embodiment of the present invention.

FIG. 2B is a second mode of a second preferred embodiment of the present invention.

FIG. 3 is a schematic view of a third preferred embodiment of the present invention.

FIGS. 4A and 4B are schematic views of a fourth preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

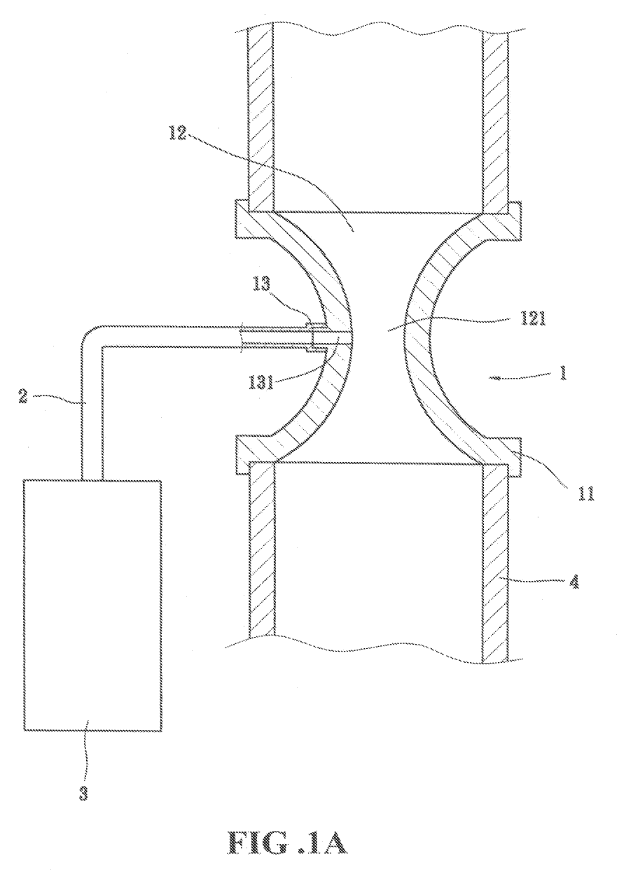

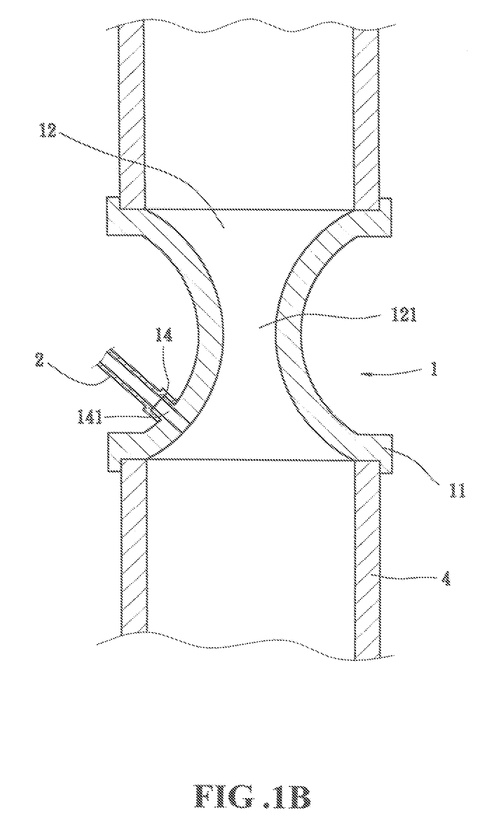

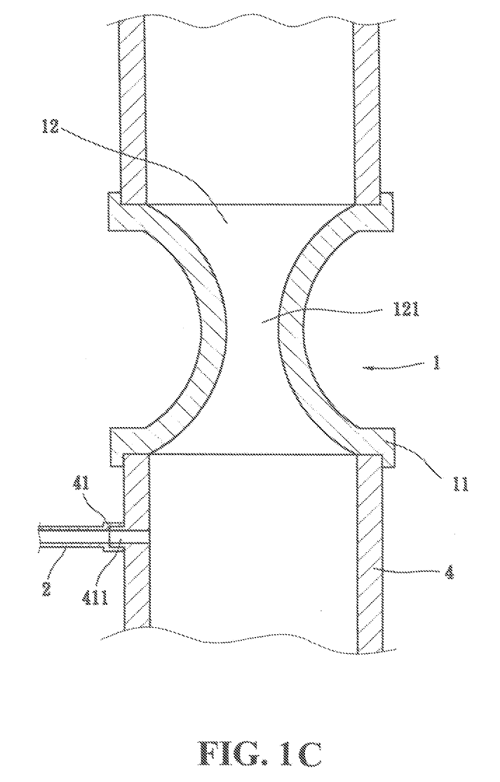

Referring to FIGS. 1A, 1B and 1C, there is shown a first preferred embodiment in accordance with the present invention. The cleaning device comprises a container 3 for storing a cleaning solution, a suction generator 1 connected to an air-inlet tube 4 of the internal combustion engine. One end portion of the suction generator 1 is mounted with a connecting section 11 for mounting to the end section of the air-inlet tube 4 or the middle section of the air-inlet tube 4. The interior of the suction generator 1 is provided with an air passage 12, and the middle section of the air passage 12 is a tapered throat 121 having a suction hole 131 at the lateral side thereof. The suction hole 131 is extended outward from a nozzle 13 for connecting to the container 3, as shown in FIG. 1A. Air passed through the throat 121 produces a nozzle effect and air stream is accelerated through the throat 121 to produce a vacuum suction, and a cleaning solution is passed through a guiding tube 2, and the section hole 131 to the throat 121, and the air stream is mixed with air into the air-inlet tube 4 to clean the cylinder of the internal combustion engine.

In the above-mentioned preferred embodiment, the suction hole 141 is provided at the air passage 12 of the suction generator 1, remote from the throat 121. As shown in FIG. 1B, the suction hole 141 is at the opening side of the end section of the air passage 12 and a nozzle 14 is externally connected to the guiding tube 2. The suction hole 141 can also be mounted at the air-inlet tube 4 close to the side of the suction generator 1, and the nozzle 41 is connected for mounting to the guiding tube 2 (as shown in FIG. 1C). The suction force produced by the air stream passed through the throat 121 to withdraw the cleaning solution in the container 3 via the guiding tube 2.

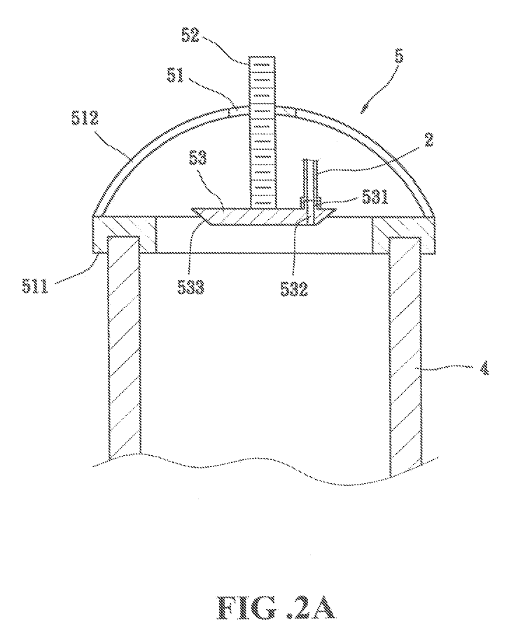

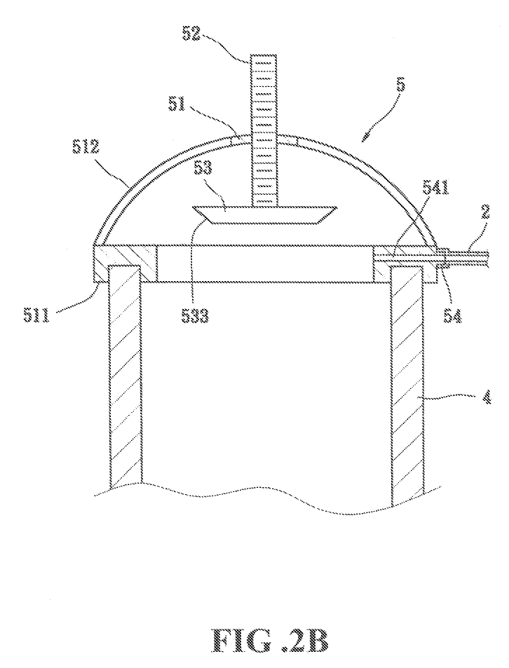

FIGS. 2A and 2B show a second preferred embodiment, and the suction generator 5 comprises a support 51, a screw rod 52 and a blocking plate 53. The circumferential edge of the bottom facing ring of the support 51 is provided with a connecting section 511 which can be mounted to the end section of the air-inlet tube 4. A plurality of hollow cavities 512 are provided on the support 51, allowing air to pass through. The screw rod 52 is vertically mounted to the center of the support 51 and the bottom end of the screw rod 52 is connected to the blocking plate 53. The circumferential edge of the blocking plate 53 is provided with a tapered edge 533. The pivotal rotating of the screw rod 52 drives the blocking plate 53 to elevate or to move down. This will change the blocking place 53 to cover the surface area of the mouth of the air-inlet tube 4. Therefore the air flow rate is adjusted.

In accordance with the preferred embodiment, a suction hole 532 is provided on the blocking plate 52, and a nozzle 531 is connected externally to the guiding tube 2 (as shown in FIG. 2A), or the connecting portion 511 of the support 51 is provided with a suction hole 541 and a nozzle 54 is externally connected to a guiding tube 2, as shown in FIG. 2B. In both cases, the suction force generated when air stream is accelerated through the circumferential edge of the blocking plate is used to suck the cleaning solution.

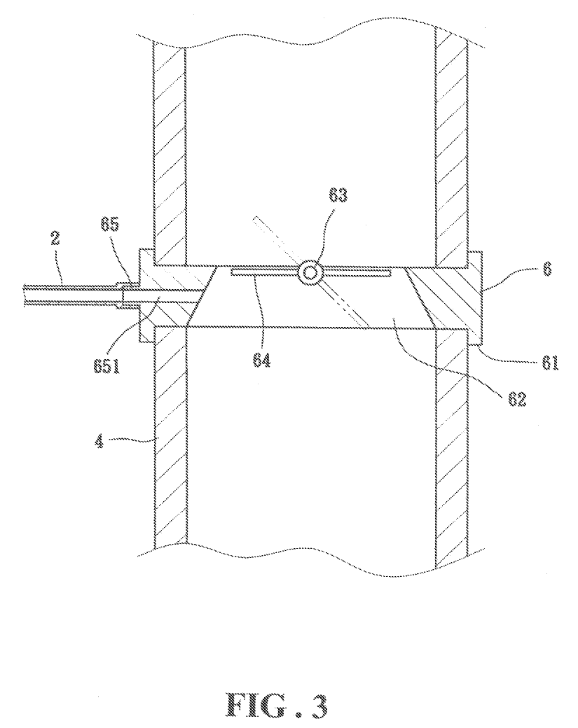

FIG. 3 illustrates a third preferred embodiment in accordance with the present invention. At least one end portion of the suction generator 6 is mounted with a connecting section for connecting to the end portion of the air-inlet tube 4, or for connecting to the middle section of the air-inlet tube 4. The center of the suction generator 6 is a tapered air passage 62, and the center of the air passage 62 is a pivotal shaft 63 combined with a blocking plate 64. The pivotal shaft 63 can be driven to rotate and this will cause the blocking plate 64 to bias to an angle so as to change the covered area of the air passage 62. Thus, the object of adjusting the air flow rate can be achieved.

In the above-preferred embodiment, the circumferential edge of the suction generator 6 is provided with a suction hole 651 and a nozzle 65 is externally connected to the guiding tube 2. The suction force generated when air stream is accelerated through the air passage 62 will withdraw the cleaning solution.

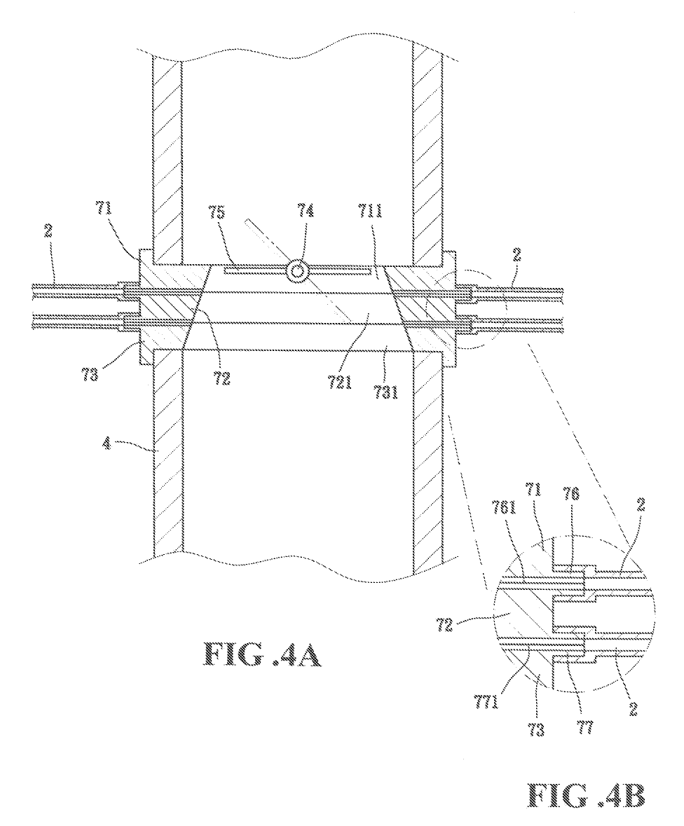

FIGS. 4A and 4B are fourth-preferred embodiments in accordance with the present invention. The suction generator 7 comprises a plurality of stacked bodies 71, 72, and 73 and is positioned at the end portion of the air-inlet tube 4 or is connected to the middle section of the air-inlet tube 4. The centers of the stacked bodies 71, 72, 73 are provided with an air passage 711, 721, 731 and can be mutually connected to form a downwardly extended air passage. The center of the utmost layer, stacked body 71, is a pivotal shaft 74 connected with a blocking plate 75. There are gaps between each adjacent bodies 71, 72, 73 and a plurality of suction holes 761, 771 are formed. These holes are respectively connected with a nozzle 76, 77, connected to a guiding tube 2.

The pivotal shaft 74 is driven to rotate such that the blocking plate 75 is biased with an angle and the covered area of the air passage is changed. This will effectively adjust the air flowrate. The suction force generated when air stream passes though the air passage will withdraw the cleaning solution.

In accordance with the above preferred embodiments. The suction generator 6 is positioned at the end portion of the air-inlet tube 4 or the front side of a relief valve at the center of the air-inlet tube 4. The sucked cleaning solution passes through the relief valve and then to the internal combustion engine. Before the cleaning solution is used to clean the internal combustion engine, the relief valve is first cleaned. Thus a dual cleaning effect is obtained. The guiding tube 2 or the opening of the contained 3 is provided with a control valve so as to control the capacity of the flowrate of the cleaning solution.

In accordance with the present invention, the cleaning device for internal combustion engine by way of suction force generated at an air-inlet tube of the internal combustion engine has increased the suction which can be appropriately controlled together with the flowrate of the cleaning solution, depending on operation conditions such as capacity of the cylinder of the engine and the effect of the cleaning.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A cleaning device for an internal combustion engine by way of suction force generated at an air-inlet tube, comprising:
a container for storing a cleaning solution;
a suction generator connected in series with the air-inlet tube of the internal combustion engine and a guiding tube connecting the container and the suction generator or the air-inlet tube;
wherein the suction generator is provided with a moveable blocking element to form an air-stream passage which has an internal diameter smaller than an internal diameter of the air inlet tube such that the air stream via the passage is accelerated to produce a suction force so as to withdraw the cleaning solution via a guiding tube into the air-inlet tube into the internal combustion engine to clean accumulated carbon or debris or the like, the moveable blocking element being capable of moving up and down to adjust area of the air-stream passage.

2. The cleaning device of claim 1, wherein the suction generator comprises a support, a screw rod and a blocking plate, a circumferential edge of a bottom face of the support is provided with a connecting section mounted to an end section of the air-inlet tube, a plurality of hollow cavities being provided on the support allowing air to pass through, the screw rod being vertically mounted to a center of the support and a bottom end of the screw rod being connected to the blocking plate.

3. The cleaning device of claim 1, wherein a circumferential edge of the blocking plate is provided with a tapered edge.

4. The cleaning device of claim 1, wherein the blocking plate is provided with a suction hole mounted with a nozzle connected to the guiding tube.

5. The cleaning device of claim 1, wherein a connecting portion of the support is provided with a suction hole mounted with a nozzle externally connected to the guiding tube.
